(19) United States
(12) Patent Application Publication
(10) Pub. No.: US 2013/0319372 A1
(43) Pub. Date: Dec. 5, 2013

(54) Internal Combustion Engine Having Piston Configured For Reduced Particulate Emissions, And Method

(71) Applicants: John Gladden, Lafayette, IN (US); Christopher L. Batta, Lafayette, IN (US)

(72) Inventors: John Gladden, Lafayette, IN (US); Christopher L. Batta, Lafayette, IN (US)

(73) Assignee: CATERPILLAR, INC., Peoria, IL (US)

(21) Appl. No.: 13/487,558

(22) Filed: Jun. 4, 2012

(51) Int. Cl. F02B 3/08; F16J 1/00

(52) U.S. Cl. 123/435

(57) ABSTRACT

An internal combustion engine includes a housing having a cylinder bore defining a bore diameter of 260 mm or greater, a fuel injector coupled to the housing, and a crankshaft rotatably coupled to the housing. A piston is coupled to the crankshaft and movable to increase a fluid pressure within the cylinder bore to an autoignition pressure, and includes a combustion face defining a plurality of valve pockets in a compound combustion bowl. Spray orifices in the fuel injector define a spray angle greater than 145°, and the combustion bowl has a diameter from 190 mm to 230 mm such that combustion of injected fuel yields a BMEP of 1600 kPa or greater and 0.25 grams particulate matter or less per bkW·h energy output of the internal combustion engine.

### TECHNICAL FIELD

The present disclosure relates generally to strategies for producing reduced amounts of particulate matter during operating an internal combustion engine, and relates more particularly to geometric attributes of a compound combustion bowl in a piston enabling production of 0.25 grams particulate matter or less per bkW·h energy output of an internal combustion engine and a BMEP of 1600 kPa or greater.

### BACKGROUND

A wide variety of operating strategies, and component geometries are known in the field of internal combustion engines. Engineers have experimented for decades with different ways to operate fueling, exhaust, intake, and other engine systems, and different ways to shape and proportion engine components for various ends. One motivation behind such experimentation has been balancing the often competing interests of reducing certain emissions in the engine exhaust and optimized efficiency. Internal combustion engines typically burn air and a hydrocarbon fuel. Combustion of the fuel and air produces exhaust including a variety of compounds and materials such as soot, ash, unburned hydrocarbons, water, carbon dioxide and carbon monoxide, and various other organic and inorganic species.

In recent years, the reduction in emissions of particulate matter, or “smoke,” has been of particular focus in combustion science research, and various jurisdictions have enacted or are expected to enact restrictions on emissions of these undesirable exhaust constituents. Unfortunately, reducing particulate matter emissions often comes at the expense of efficiency properties such as fuel efficiency and/or attainable engine speed and power. As noted above, component shapes and engine operating parameters have been varied in almost innumerable ways over the years. One area of extensive research and experimentation in combustion science relates to attempts to shape a piston combustion face in such a way that certain exhaust emissions, including particulate matter emissions, are reduced without unduly sacrificing efficiency.

One piston design directed to such goals includes a combustion bowl defined by the combustion face of the piston exposed to and defining a portion of the engine combustion chamber when placed in service. It is believed that combustion bowls, and certain bowl geometries, can affect the flow and combustion properties of gases and atomized liquid fuel during a combustion event in such a way that the make-up of combustion products can be tailored for various purposes. Many such combustion bowl designs are directed to reducing one or both of oxides of nitrogen (NOx) and particulate matter. One known combustion bowl design optimized for both efficiency and multiple types of emissions is known from commonly owned U.S. patent application Ser. No. 13/088,659 to Easley et al., now U.S. Pat. No. ______.

Still other strategies have focused less on balancing the relative amounts of certain emissions, and are directed more towards, say, reduced NOx or reducing particulate matter, not both. Such strategies may be advantageous where jurisdictional requirements are relatively more stringent for one type of exhaust constituent, or where some other means for eliminating or trapping certain undesired emissions is used. Despite the development of numerous research and commercial designs for piston combustion bowls, as well as other factors relating to exhaust emissions, the science of combustion is not fully understood. This is particularly the case as the science of combustion relates to combustion bowl shape and other geometric properties. It is well known that even relatively minor modifications to combustion bowl geometry can have significant effects on the type and relative proportions of combustion products. Due to this lack of sufficient understanding, the art provides relatively little guidance on how to achieve any specific set of goals. While engineers have discovered many different variables which they know will have some effect on emissions and/or efficiency, the grouping of these variables, their cross-coupling, and other factors do not often result in satisfactory and predictable results. Moreover, even where a design is found suitable for one type of engine system, the design may not successfully scale to relatively larger or relatively smaller engines, or be applicable outside a specific combination of engine operating factors. Developing a suitable piston configuration, which will achieve certain goals within a fairly strictly defined set of engine operating parameters, remains elusive and often requires years of research and development including thorough application, testing and even field service analysis.

### SUMMARY

In one aspect, a method of operating an internal combustion engine includes increasing a fluid pressure within a cylinder bore of the internal combustion engine to an autoignition pressure via moving a piston within a cylinder bore toward a top dead center position, the cylinder bore having a bore diameter of 260 mm or greater, and the piston having a stroke distance equal to or greater than the bore diameter. The method further includes advancing a combustion face of the piston through the cylinder bore during increasing the fluid pressure, the combustion face defining a plurality of valve pockets and a compound combustion bowl having a bowl diameter from 190 mm to 230 mm, and injecting a fuel directly into the cylinder bore at a spray angle greater than 145° while the fluid pressure is at or above the autoignition pressure. The method further includes combusting the injected fuel and air such that the piston is urged toward a bottom dead center position within the cylinder via a BMEP of 1600 kPa or greater and the combustion yields 0.25 grams particulate matter or less per bkW·h energy output of the internal combustion engine.

In another aspect, an internal combustion engine includes a housing having a cylinder bore formed therein and defining a bore diameter of 260 mm or greater, a fuel injector coupled to the housing and defining a plurality of spray orifices positioned within the cylinder bore to directly inject a fuel therein, and a crankshaft rotatably coupled to the housing. The engine further includes a piston coupled to the crankshaft and movable within the cylinder bore a stroke distance equal to or greater than the bore diameter from a bottom dead center position to a top dead center position, to increase a fluid pressure within the cylinder bore to an autoignition pressure. The piston further includes an outer peripheral surface defining a center axis, and extending between a first axial end of the piston and a second axial end having a combustion face defining a plurality of valve pockets and a compound combustion bowl. The plurality of spray orifices define a spray angle greater than 145°, and the compound combustion bowl has a bowl diameter from 190 mm to 230 mm, such that upon injecting the fuel and when the fluid pressure is at or above the autoignition pressure, a mixture of the injected fuel and air within the cylinder bore combusts to urge the piston toward the top dead center position via a BMEP of 1600 kPa or greater and the combustion yields 0.25 grams particulate matter or less per bkW·h energy output of the internal combustion engine.

In still another aspect, a piston crown configured to couple with a piston skirt to form a piston is provided, the piston being positionable within a cylinder bore of a direct injection internal combustion engine having a bore diameter of 260 mm or greater, and movable a stroke distance within the cylinder bore equal to or greater than the bore diameter from a bottom dead center position to a top dead center position to increase a fluid pressure within the cylinder bore to an autoignition pressure. The piston crown includes a body having an outer peripheral surface defining a center axis, and extending between a first axial body end and a second axial body end, the body further having an axial body length and a body diameter greater than the axial body length. The body further includes a cooling void formed in the first axial body end, a bolting aperture extending axially inward from the cooling void, for receiving a bolt to attach the piston skirt to the piston crown, and a combustion face upon the second axial body end defining a plurality of valve pockets and a compound combustion bowl. The combustion face further forms a convex center cone within the compound combustion bowl, and a concave curvilinear wall transitioning from the convex center cone to a straight cylindrical wall oriented parallel to the center axis and adjoining a convex lip of the compound combustion bowl. The compound combustion bowl has a bowl diameter which is from 190 mm to 230 mm and equal to two-thirds of the body diameter or greater, and an axial bowl depth equal to one-tenth of the bowl diameter or greater, such that upon injecting a fuel into the cylinder bore at a spray angle greater than 145° and when the fluid pressure is at or above the autoignition pressure, a mixture of the fuel and air within the cylinder bore combusts to urge the piston toward the bottom dead center position via a BMEP of 1600 kPa or greater and the combustion yields 0.25 grams particulate matter or less per bkW·h energy output of the internal combustion engine.

### BRIEF DESCRIPTION OF THE DRAWINGS

FIG. 1 is a partially sectioned side diagrammatic view of an internal combustion engine according to one embodiment;

FIG. 2 is an isometric view of a piston suitable for use in the engine of FIG. 1;

FIG. 3 is a partially sectioned side diagrammatic view of a portion of the engine of FIG. 1;

FIG. 4 is an interaction plot of particulate matter production for different piston designs; and

FIG. 5 is an interaction plot of fuel consumption for the two different piston designs.

### DETAILED DESCRIPTION

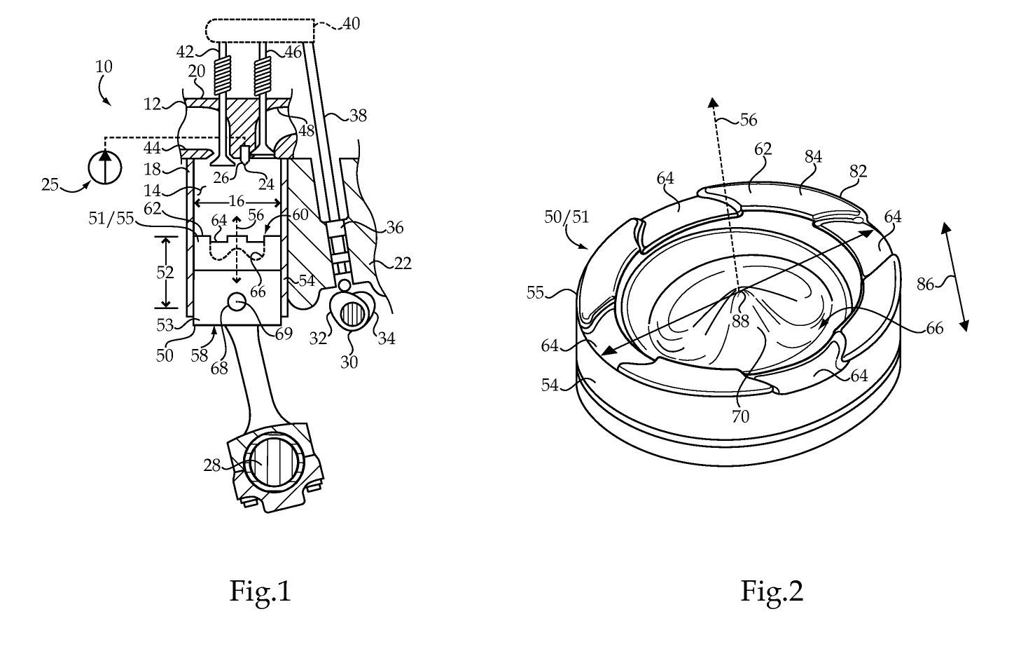

Referring to FIG. 1, there is shown an internal combustion engine 10 according to one embodiment, and having a housing 12 with a cylinder bore 14 formed therein. In the illustrated embodiment, cylinder bore 14 is formed in a cylinder liner 18 positioned within a cylinder block 22 and coupled with a head 20 in a conventional manner. Engine 10 may include a compression ignition diesel engine, having a fuel injector 24 coupled to housing 12 and configured to directly inject a fuel such as a diesel distillate fuel into cylinder bore 14. Fuel injector 24 may be fluidly connected with a source of pressurized fuel 25 comprising a pump. In certain embodiments, engine 10 may include a plurality of cylinder bores, and in such an embodiment fuel source 25 might also include a common rail, for reasons which will be apparent to those skilled in the art. Fuel injector 24 further defines a plurality of spray orifices 26 positioned within cylinder bore 14, and having a number from eight to twelve, and in a practical implementation strategy ten.

Engine 10 further includes a crankshaft 28 rotatably coupled to housing 12 in a conventional manner, and a camshaft 30 rotatably coupled to crankshaft 28, typically via a gear train (not shown). Camshaft 30 may include a plurality of cams, for instance a first cam 32 and a second cam 34. Cam 32 may rotate in contact with a valve lifter 36 coupled to a first or intake valve 42 configured to open and close an intake passage 44 formed in head 12 for conveying intake air into cylinder bore 14. A pushrod 38 couples valve lifter 36 with valve 42 via a rocker arm assembly 40. Cam 34 may rotate in contact with a second valve lifter, pushrod, and rocker arm assembly, which are obscured in the FIG. 1 illustration, and coupled to a second or exhaust valve configured to open and close an exhaust passage 48 formed in head 12, for conveying exhaust out of cylinder bore 14. Intake cam 32 and exhaust cam 34 may be profiled such that both intake valve 42 and exhaust valve 46 are open upon commencing moving a piston 50 from a top dead center position within cylinder bore 14 to a bottom dead center position in an intake stroke of engine 10, the significance of which will be apparent from the following description.

In a practical implementation strategy, engine 10 may be a medium-size diesel engine, where cylinder bore 14 has a bore diameter 16 of 260 millimeters (mm) or greater, potentially up to several tens of millimeters more than 260 mm. Dimensions and proportions noted herein may vary somewhat from exact specifications, and thus should be generally understood in the context of conventional rounding. Thus, a bore diameter of 255 mm could be conventionally rounded to 260 mm in accordance with this general understanding. Piston 50 is coupled to crankshaft 28 and movable within cylinder bore 14 a stroke distance 52 equal to or greater than bore diameter 16 from the bottom dead center position to the top dead center position, to increase a fluid pressure within cylinder bore 14 to an autoignition pressure. As will be further apparent from the following description, piston 50 may be uniquely configured to enable combustion of injected fuel and air at or above the autoignition pressure within cylinder bore 14 such that relatively low amounts of particulate matter are produced via the combustion under at least certain operating conditions of engine 10. To this end, piston 50 includes an outer peripheral surface 54 defining a center axis 56, and extending between a first axial end 58 of piston 50 and a second axial end 60 having a combustion face 62 defining a plurality of valve pockets 64 and a compound combustion bowl 66. In a practical implementation strategy, piston 50 includes a crown 51 having a body 55 coupled to a skirt 53 with a wrist pin 68 positioned therein and having a wrist pin axis 69, whereby piston 50 is coupled with crankshaft 28.

Referring also now to FIG. 2, there is shown a diagrammatic view of crown 51 illustrating additional features thereof, and in more detail. Body 55 may have an axial body length 86, and a body diameter 88 greater than axial body length 86. In the illustrated embodiment, combustion face 62 forms a convex cone 70 within combustion bowl 66. Combustion face 62 further forms a rim 82 adjoining outer peripheral surface 54 and having valve pockets 64 formed therein. Rim 82 may also include a plurality of plateaus 84 in an alternating arrangement with valve pockets 64. In a practical implementation strategy valve pockets 64 may include a total of four valve pockets, corresponding with two exhaust valves and two intake valves, as further described herein, and a total of four plateaus 84. Plateaus 84 may define a common plane which is oriented normal to center axis 56.

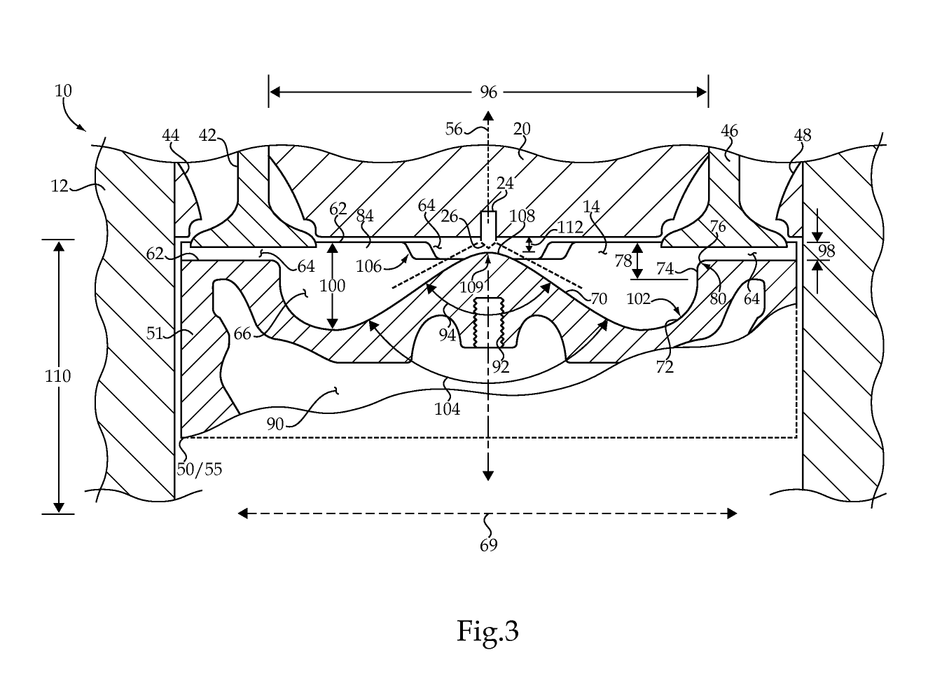

Referring also now to FIG. 3, there is shown a sectioned view through engine 10 illustrating additional features of engine 10 and piston 50, in particular geometric features of combustion bowl 66. As noted above, intake and exhaust cams 32 and 34 may be profiled such that both intake and exhaust valves 42 and 46 are open upon commencing moving piston from the top dead center position to the bottom dead center position in an intake stroke. In FIG. 3, piston 50 is shown as it might appear at or close to the top dead center position, and upon or just prior to commencing moving toward the bottom dead center position. It may be noted that intake valve 42 and exhaust valve 46 are both open such that both intake passage 44 and exhaust passage 48 are in fluid communication with cylinder bore 14. As discussed above, engine 10 may be a medium-size diesel engine, having exemplary medium power output applications in electrical power generation, off-shore oil and gas production, and locomotive propulsion. Engines in this general size class often have a duty cycle which includes many hours operating at greater than 80% maximum rated load and even greater than 90% maximum rated load. For this and other reasons, in many instances cooling such engines may be relatively more challenging than smaller engines and those having more dynamic duty cycles where lower load and idle operation can be expected periodically. Configuring cams 32 and 34 such that fluid communication between both intake passage 44 and exhaust passage 48 and cylinder bore 14 occurs for a time after beginning to move piston 50 toward the bottom dead center position enables some intake air to be transferred from intake passage 44 through cylinder bore 14 and into exhaust passage 48 without being burned. In certain embodiments, approximately 5% of the volumetric throughput of gases through engine 10 may include unburned intake air conveyed in this general manner. Another way to understand these principles is that piston 50 has been moved toward the top dead center position while exhaust valve 46 is open to expel exhaust, containing particulate matter and other exhaust constituents, from cylinder bore 14. And, rather than closing exhaust valve 46 upon or prior to piston 50 reaching the top dead center position, exhaust valve 46 may remain open and be received within one of valve pockets 64 when piston 50 reaches and passes the top dead center position at the end of the exhaust stroke expelling the exhaust. While exhaust valve 46 is open, albeit moving towards a closed position, intake valve 42 may be opened to convey intake air through cylinder bore 14 as described herein. Exhaust valve 46 will then close, after commencing conveying intake air into cylinder bore 14 such that the intake air is passed through the cylinder bore into exhaust passage 48. It may also be noted from FIG. 3, as well as in FIG. 1, that head 20 may be designed such that each of intake valve 42 and exhaust valve 46 may be recessed in their closed positions, for example 5 mm, from a surface of engine head 20 facing cylinder bore 14.

As noted above, fuel injector 24 may be connected with a source of pressurized fuel such as a unit pump or a common rail, and might additionally or alternatively include a fuel pressurization plunger, to enable injection of the pressurized fuel into cylinder bore 14. In contrast to known strategies which attempt to reduce certain emissions in part via fuel injection at very high pressures, in engine 10 fuel injection may occur at a relatively low pressure while still achieving acceptable emissions. In particular, fuel injection from fuel injector 24 may occur at an injection pressure less than 150 megapascals (MPa), and may further occur at an injection pressure of 140 MPa or less. A start of injection time may occur prior to piston 50 reaching the top dead center position during increasing the fluid pressure in cylinder bore 14 to the autoignition pressure. In a practical implementation strategy, the start of injection time may occur at a crank angle of 10° or greater before top dead center. Spray orifices 26, arranged for example in a single row, may define a spray angle 94 greater than 145°, and in one practical implementation strategy a spray angle equal to 155°.

As noted above, certain geometric features of combustion bowl 66 are considered to facilitate the desired operation and emissions profile of engine 10 described herein. To this end, combustion bowl 66 may have a bowl diameter 96 from 190 mm to 230 mm and equal to two-thirds of body diameter 88 or greater. In engine 10, spray angle 94 being greater than 145° and bowl diameter 96 being from 190 mm to 230 mm facilitates injection of the fuel, when the fluid pressure in cylinder bore 14 is at or above the autoignition pressure, such that a mixture of the injected fuel and air within cylinder bore 14 combusts to urge piston 50 toward the bottom dead center position via a brake mean effective pressure (BMEP) of 1600 kilopascals (kPa) or greater and the combustion yields 0.25 grams particulate matter or less per brake kilowatt-hour (bkW·h) energy output of engine 10. Combustion of the injected fuel and air may occur to produce such a combustion/emissions profile where crankshaft 28 is rotated at what will be understood by those skilled in the art as a medium speed for diesel engines of 900 rpm to 1000 rpm, although the present disclosure is not thereby limited. In at least certain instances in engines contemplated herein, the piston may be urged towards its bottom dead center position via a BMEP of 1800 kPa or greater and such that the combustion yields 0.1 grams particulate matter or less per bkW·h energy output of the internal combustion engine.

Still other features of piston 50, in particular piston crown 51, support and enhance the capability of engine 10 to operate in the manner described herein. To this end, it may be noted from FIG. 3 that combustion face 62 forms a concave curvilinear wall 72 transitioning from convex cone 70 to a straight cylindrical wall 74 adjoining a lip 76 of combustion bowl 66, cylindrical wall 74 being oriented parallel to center axis 56. Wall 74 may further have an axial height 78 between 5 mm and 10 mm, and equal to 7 mm in a practical implementation strategy. Wall 72 may define a concave radius of curvature 102 between 15 mm and 25 mm, and equal to 22 mm in a practical implementation strategy. Lip 76 may define a convex radius of curvature 80 greater than 2 mm. Radius of curvature 80 may be between 2 mm and 4 mm, and equal to 3 mm in a practical implementation strategy. It will be recalled that plateaus 84 define a common plane, in FIG. 3 the common plane being parallel to the surface of head 20 facing and exposed to cylinder bore 14. Combustion bowl 66 may have an axial bowl depth 100 of 25 mm or greater extending from the subject plane to a bottom of combustion bowl 66, the bottom being the portion of bowl 66 positioned at an axially lowermost location in FIG. 3. Bowl depth 100 may be equal to one-tenth of bowl diameter 96 or greater, and in a practical implementation strategy may be equal to 32 mm.

Certain geometric features of convex center cone 70 also are believed to contribute to reliably operating engine 10 in the manner described herein. In a practical implementation strategy, cone 70 defines a cone angle 104 less than spray angle 94, and in any event typically less than 145°, and has an apex 108 positioned axially between the plane defined by plateaus 84 and bottoms of valve pockets 64 located at an axial pocket depth 98 from the subject plane. In one embodiment, apex 108 may define an apex radius 109 equal to 20 mm. Axial pocket depth 98 may be 5 mm or greater in a practical implementation strategy. Apex 108 may also be positioned at a cone depth 112 from the plane defined by plateaus 84, cone depth 112 being 4 mm or less, and equal to 3.25 mm in a practical implementation strategy. A pocket radius 106 is also shown transitioning between one of pockets 64 and plateaus 84. Pocket radius 106 may be 5 mm or greater in a practical implementation strategy.

In FIG. 3, piston 50 is shown without skirt 53 to illustrate additional features, namely, a cooling void 90 which receives a spray of cooling liquid such as engine lubricating oil during service in engine 10. Analogous to the description herein of first and second axial ends of the overall piston 50, body 55 forming piston crown 51 may be understood to have first and second axial body ends, and cooling void 90 is formed in the first axial body end. A bolting aperture 92 extends axially inward from cooling void 90 for receiving a bolt (not shown) to attach piston skirt 53 to piston crown 51. Combustion face 62 will be understood to be formed upon the second axial body end. Also shown in FIG. 3 is wrist pin axis 69. Providing valve pockets 64 in piston crown 51 enables piston crown 51 to be made relatively taller than certain earlier known piston designs used in the general class of engines of which engine 10 is one example. In particular, by providing some clearance for valves 42 and 46, at the top dead center position of piston 50 combustion face 62 may approach head 20 quite closely, reducing crevice volume that could otherwise be occupied by gases less susceptible to combustion. In a practical implementation strategy, an axial height 110 from axis 69 to the plane defined by plateaus 84 may be from 93 mm to 97 mm.

### INDUSTRIAL APPLICABILITY

As discussed above, a multitude of strategies exist which tailor geometric properties of pistons and other internal combustion engine components to achieve particular aims. Success in reducing certain emissions to or below target levels often comes with a tradeoff in the production of other emissions or factors such as engine efficiency and service life. Accordingly, an emissions reduction strategy based on the geometry of a piston suitable for use in one class of engines, or one suite of operating conditions, may not work or be impractical when applied in a different type of engine or where certain operating parameters are varied from a narrowly specified profile. In the case of relatively large bore, medium-power output diesel engines, of which engine 10 is one example, certain solutions to emission problems known for smaller bore engines are unavailable. As alluded to above, diesel engines used in electrical power generation, locomotive and marine applications may have very demanding duty cycles, running for hundreds of hours at load conditions above 80% maximum rated load or even higher. Such service characteristics are distinctly different from on and off-highway engines used for many trucks and construction machines, for instance. Since it is also typically quite expensive to service engines of this general class, it is especially desirable to design components which can withstand harsh service conditions for very long service lives, such as 10,000 hours or more.

By way of example, certain known combustion bowl designs used to produce relatively low particulates employ a reentrant bowl surrounded by a sharp combustion lip. While successful in its particular service environment, such a combustion bowl design may be less likely to survive under the service conditions contemplated to apply to engine 10 and similar engines. This would be expected at least for the reason that the very long periods of high load operation in such engines could be expected to create a risk of cracking a sharp edge on a combustion bowl lip and potentially leading to catastrophic failure. Accordingly, the present disclosure contemplates a relatively less sharply radiused lip, as described herein. Other surfaces and interfaces of piston 50 may be formed with relatively larger radiuses for analogous purposes. As another example, certain engine systems are designed with very high fuel injection pressures, even approaching 300 MPa, at least in part for the purpose of ensuring as complete a combustion of injected fuel as possible, and in certain instances reduced particulate matter emissions. While fuel systems capable of achieving such injection pressures could theoretically be used with engines of the type contemplated herein, the costs of manufacturing and maintaining such systems as compared with lower injection pressure systems is non-trivial, and thus the presently described developments which enable reduced particulate matter emissions at lower injection pressured are advantageous.

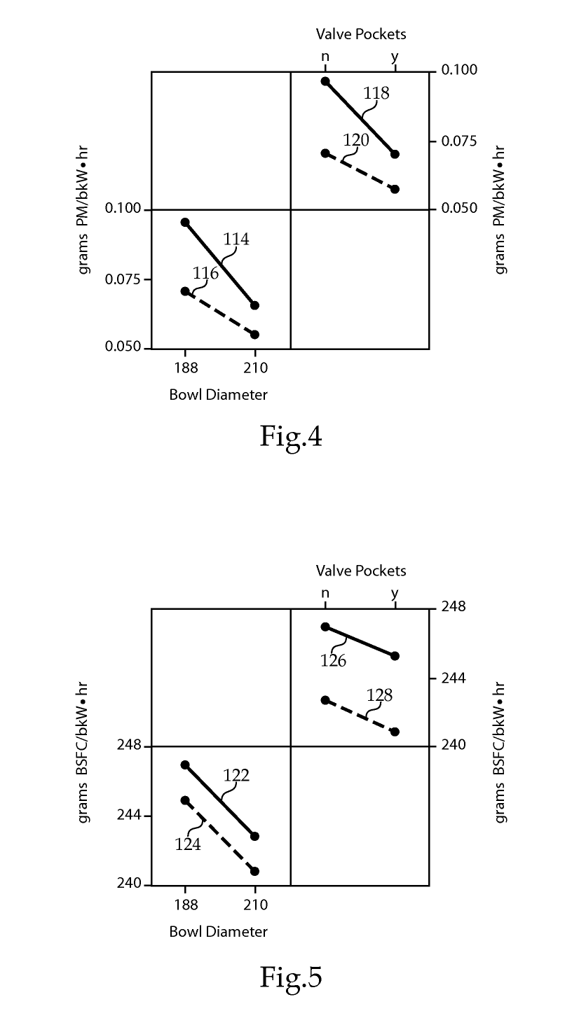

Referring now to FIG. 4, there is shown an interaction plot illustrating averaged experimental data based upon test cell operation of a plurality of pistons in single cylinder set-ups, and under operating conditions as discussed herein. FIG. 4 illustrates effects of experimentally varying bowl diameter on particulate matter output in the lower left quadrant of the plot, and the effects of the presence or absence of valve pockets on particulate matter emissions in the upper right quadrant of the plot. A first curve 114 illustrates effects of combustion bowl diameter varying from 188 mm to 210 mm where valve pockets are not used. A second curve 116 illustrates effects of varying bowl diameter from 188 mm to 210 mm where valve pockets are used. The data reflected in curves 114 and 116 illustrates, among other things, that the mere presence of valve pockets can contribute substantially to reduced particulate matter emissions. Another curve 118, in the upper right quadrant, represents effects of the presence or absence of valve pockets where combustion bowl diameter in a piston is 188 mm, whereas another curve 120 represents effects of the presence or absence of valve pockets where bowl diameter is 210 mm. Data reflected in curves 118 and 120, taken in conjunction with curves 114 and 116, can be understood to convey that bowl diameter made larger can further enable low particulate emissions, and especially in combination with valve pockets, provide for particulate emissions at and even below target levels of 0.25 grams PM/bkW·h.

As further noted above, certain known strategies sacrifice efficiency in favor of emissions reduction/control. The present disclosure, however, attains acceptable efficiency without making such sacrifices. FIG. 5 is another interaction plot illustrating averaged experimental data obtained analogously to that of FIG. 4, and including a first curve 122 and a second curve 124 reflecting fuel efficiency data for pistons having bowl diameters from 188 mm to 210 mm, without pockets and with pockets respectively. Another curve 126 and yet another curve 128 reflect a piston having a bowl diameter of 188 mm versus a piston having a bowl diameter of 210 mm, and having valve pockets versus lacking valve pockets. In certain embodiments, the present disclosure contemplates combusting fuel and air, such that the combustion yields a brake specific fuel consumption (BSFC) of 250 grams fuel or less per bkW·h energy output of the internal combustion engine, and as reflected in FIG. 5 potentially even less.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims.

What is claimed is:

1. A method of operating an internal combustion engine comprising the steps of:
increasing a fluid pressure within a cylinder bore of the internal combustion engine to an autoignition pressure via moving a piston within the cylinder bore toward a top dead center position, the cylinder bore having a bore diameter of 260 mm or greater, and the piston having a stroke distance equal to or greater than the bore diameter;
advancing a combustion face of the piston through the cylinder bore during the step of increasing, the combustion face defining a plurality of valve pockets and a compound combustion bowl having a bowl diameter from 190 mm to 230 mm;
injecting a fuel directly into the cylinder bore at a spray angle greater than 145° while the fluid pressure is at or above the autoignition pressure; and
combusting the injected fuel and air such that the piston is urged toward a bottom dead center position within the cylinder via a BMEP of 1600 kPa or greater and the combustion yields 0.25 grams particulate matter or less per bkW·h energy output of the internal combustion engine.

2. The method of claim 1 wherein the step of combusting further includes combusting the fuel and air such that the combustion yields a BSFC of 250 grams fuel or less per bkW·h energy output of the internal combustion engine, and the method further comprising a step of rotating a crankshaft coupled with the piston in response to the combusting step at an average speed of rotation from 900 RPM to 1000 RPM.

3. The method of claim 2 wherein the combustion face forms a cone within the combustion bowl defining a large convex radius of curvature, and a curvilinear wall defining a concave radius of curvature and transitioning within the combustion bowl from the cone to a straight wall oriented parallel to a center axis of the piston and adjoining a lip of the combustion bowl defining a small convex radius of curvature.

4. The method of claim 3 wherein the step of combusting further includes combusting the fuel and air such that the piston is urged toward the bottom dead center position via a BMEP of 1800 kPa or greater and the combustion yields 0.1 grams particulate matter or less per bkW·h energy output of the internal combustion engine.

5. The method of claim 3 wherein the step of injecting further includes injecting the fuel from a total of 8 to 12 spray orifices of the fuel injector at an injection pressure less than 150 MPa and at a start of injection time occurring prior to the piston reaching the top dead center position during the increasing step.

6. The method of claim 5 further comprising the steps of expelling exhaust containing the particulate matter from the cylinder bore via moving the piston back toward the top dead center position while an exhaust valve from the cylinder bore is open, and receiving the exhaust valve within one of the plurality of valve pockets when the piston reaches the top dead center position at the end of the expelling step.

7. The method of claim 6 further comprising the steps of:
conveying intake air into the cylinder bore via moving the piston back toward the bottom dead center position after the expelling step and while an intake valve to the cylinder bore is open; and
cooling the internal combustion engine via closing the exhaust valve after commencing the conveying step such that intake air is passed through the cylinder bore into an exhaust passage.

8. An internal combustion engine comprising:
a housing having a cylinder bore formed therein and defining a bore diameter of 260 mm or greater;
a fuel injector coupled to the housing and defining a plurality of spray orifices positioned within the cylinder bore to directly inject a fuel therein;
a crankshaft rotatably coupled to the housing;
a piston coupled to the crankshaft and movable within the cylinder bore a stroke distance equal to or greater than the bore diameter from a bottom dead center position to a top dead center position, to increase a fluid pressure within the cylinder bore to an autoignition pressure;
the piston including an outer peripheral surface defining a center axis, and extending between a first axial end of the piston and a second axial end having a combustion face defining a plurality of valve pockets and a compound combustion bowl; and
the plurality of spray orifices defining a spray angle greater than 145°, and the compound combustion bowl having a bowl diameter from 190 mm to 230 mm, such that upon injecting the fuel and when the fluid pressure is at or above the autoignition pressure, a mixture of the injected fuel and air within the cylinder bore combusts to urge the piston toward the bottom dead center position via a BMEP of 1600 kPa or greater and the combustion yields 0.25 grams particulate matter or less per bkW·h energy output of the internal combustion engine.

9. The internal combustion engine of claim 8 wherein the combustion face forms a convex cone within the combustion bowl, and a concave curvilinear wall transitioning from the convex cone to a straight cylindrical wall adjoining a lip of the combustion bowl and being oriented parallel to the center axis.

10. The internal combustion engine of claim 9 wherein the straight wall has an axial height between 5 mm and 10 mm, and the lip defines a convex radius of curvature greater than 2 mm.

11. The internal combustion engine of claim 10 wherein the combustion face forms a rim adjoining the outer peripheral surface and having the plurality of valve pockets formed therein, and wherein the rim includes a plurality of plateaus in an alternating arrangement with the valve pockets, and each of the valve pockets has an axial depth of 5 mm or greater.

12. The internal combustion engine of claim 11 wherein the plurality of plateaus define a plane normal to and intersecting the center axis, and the combustion bowl has a bowl depth of 25 mm or greater extending from the plane to a bottom of the combustion bowl.

13. The internal combustion engine of claim 9 further comprising an intake valve and an exhaust valve for the cylinder, and a camshaft coupled with the crankshaft and having an intake cam and an exhaust cam respectively coupled with the intake and exhaust valves to control opening and closing of the same, and wherein the intake and exhaust cams are profiled such that both the intake and exhaust valve are open upon commencing moving the piston from the top dead center position to the bottom dead center position in an intake stroke of the internal combustion engine.

14. A piston crown configured to couple with a piston skirt to form a piston positionable within a cylinder bore of a direct injection internal combustion engine having a bore diameter of 260 mm or greater, and movable a stroke distance within the cylinder bore equal to or greater than the bore diameter from a bottom dead center position to a top dead center position to increase a fluid pressure within the cylinder bore to an autoignition pressure, the piston crown comprising:
a body including an outer peripheral surface defining a center axis, and extending between a first axial body end and a second axial body end, the body further having an axial body length and a body diameter greater than the axial body length;
the body further including a cooling void formed in the first axial body end, a bolting aperture extending axially inward from the cooling void, for receiving a bolt to attach the piston skirt to the piston crown, and a combustion face upon the second axial body end defining a plurality of valve pockets and a compound combustion bowl;
the combustion face further forming a convex center cone within the compound combustion bowl, and a concave curvilinear wall transitioning from the convex center cone to a straight cylindrical wall oriented parallel to the center axis and adjoining a convex lip of the compound combustion bowl; and
the compound combustion bowl having a bowl diameter which is from 190 mm to 230 mm and equal to two-thirds of the body diameter or greater, and an axial bowl depth equal to one-tenth of the bowl diameter or greater, such that upon injecting a fuel into the cylinder bore at a spray angle greater than 145° and when the fluid pressure is at or above the autoignition pressure, a mixture of the fuel and air within the cylinder bore combusts to urge the piston toward the bottom dead center position via a BMEP of 1600 kPa or greater and the combustion yields 0.25 grams particulate matter or less per bkW·h energy output of the internal combustion engine.

15. The piston crown of claim 14 wherein the combustion face further forms a rim adjoining the outer peripheral surface and having the plurality of valve pockets formed therein, and wherein the plurality of valve pockets include a total of four and the rim further includes a total of four plateaus in an alternating arrangement with the valve pockets and defining a common plane oriented normal to the center axis.

16. The piston crown of claim 15 wherein each of the plurality of valve pockets has an axial pocket depth of 5 mm or greater, and the combustion bowl has an axial bowl depth of 25 mm or greater.

17. The piston crown of claim 16 wherein the straight cylindrical wall has an axial height between 5 mm and 10 mm, the concave curvilinear wall defines a concave radius of curvature between 15 mm and 25 mm, and the convex lip defines a convex radius of curvature between 2 mm and 4 mm.

18. The piston crown of claim 17 wherein the bowl diameter is 210 mm, the axial bowl depth is 32 mm, the axial height of the straight wall is 7 mm, the concave radius of curvature is 22 mm, and the convex radius of curvature is 3 mm.

19. The piston crown of claim 17 wherein the convex center cone defines a cone angle less than 145° and has an apex positioned axially between the plane and bottoms of the valve pockets located at the axial pocket depth.
